(19) United States
(12) Patent Application Publication
(10) Pub. No.: US 2007/0085806 A1
(43) Pub. Date: Apr. 19, 2007

(54) Driving voltage generating circuit, liquid crystal display having the same and method of generating driving voltage

(75) Inventor: Seung-Hwan Moon, Yongin-si (KR)

Correspondence Address: MACPHERSON KWOK CHEN & HEID LLP, 2033 GATEWAY PLACE, SUITE 400, SAN JOSE, CA, 95110, US

(73) Assignee: Samsung Electronics Co., Ltd.

(21) Appl. No.: 11/544,133

(22) Filed: Oct. 6, 2006

(30) Foreign Application Priority Data
Oct. 18, 2005 (KR) 2005-98214

(51) Int. Cl. G09G 3/36

(52) U.S. Cl. 345/98

(57) ABSTRACT

In a liquid crystal display, a driving voltage generating circuit generates a driving power voltage and a gate on voltage substantially in inverse proportion to a temperature variation of an ambient temperature. A data driver outputs a data signal in response to the driving power voltage and a gate driver outputs a gate signal in response to the gate on voltage. A liquid crystal display panel displays an image in response to the data signal and the gate signal.

### CROSS-REFERENCE TO RELATED APPLICATION

This application claims priority from Korean Patent Application No. 2005-98214 filed on Oct. 18, 2005, the contents of which are herein incorporated by reference in its entirety.

### BACKGROUND OF THE INVENTION

1. Field of the Invention

The present invention relates to a liquid crystal display. More particularly, the present invention relates to a driving voltage generating circuit, a liquid crystal display having the driving voltage generating circuit and a method of generating the driving voltage.

2. Description of the Related Art

An image displayed on a liquid crystal display is sometimes distorted because of the temperature of a place where the liquid crystal display is located. That is, when the temperature of the place is lower than typical room temperature, the image displayed on the liquid crystal display can become a white color, and when the temperature of the place is higher than typical room temperature, the image displayed on the liquid crystal display becomes black in color.

Distortion of the image displayed on the liquid crystal display due to a temperature variation of the environment is caused by an operational characteristic of a thin film transistor with respect to the temperature of the environment, and a transmittance characteristic of liquid crystal of the liquid crystal display with respect to the environment. In other words, when the temperature of the environment is lower than the room temperature, a rate of charge of the liquid crystal capacitor is lowered because the operational characteristic of the thin film transistor is reduced, and when the temperature of the environment is higher than the room temperature, the rate of charge of the liquid crystal capacitor is higher since the operational characteristic of the thin film transistor is improved.

Also, the transmittance of the liquid crystal is determined by a voltage difference between a common voltage applied to a common electrode of the liquid crystal display and a pixel voltage applied to a pixel electrode of the liquid crystal display. However, although the voltage difference between the common voltage and the pixel voltage is uniformly maintained, the transmittance of the liquid crystal decreases when the liquid crystal display is used in an environment where the temperature lower than the room temperature, and the transmittance of the liquid crystal increases when the liquid crystal display is used in an environment where the temperature is higher than the room temperature.

As a result, the quality of the image displayed on the liquid crystal display is reduced due to the temperature variation.

### SUMMARY OF THE INVENTION

The present invention provides a driving voltage generating circuit capable of preventing deterioration of an image display quality.

The present invention also provides a liquid crystal display having the above driving voltage generating circuit.

The present invention also provides a method suitable for generating the above driving voltage.

In one aspect of the present invention, a driving voltage generating circuit includes a switching voltage generator circuit, a temperature-compensation feedback circuit, a driving power voltage generator circuit and a gate on voltage generator circuit.

The switching voltage generator circuit is adapted to provide at an output terminal an output voltage. The switching voltage generator circuit has a control terminal for receiving a voltage control signal and generating a magnitude at the output voltage as a function of the voltage control signal. The temperature-compensation feedback part provides at an output terminal the control signal having a value which is a function of an ambient temperature. The output terminal of the temperature compensation feedback circuit is coupled to the control terminal of the switching voltage generator circuit. The driving power voltage generator circuit rectifies the switching driving voltage and generates a driving power voltage that is substantially inversely proportional to a temperature variation of the ambient temperature. The gate on voltage generator circuit pumps the switching driving voltage and generates a gate on voltage that is substantially inversely proportional to the temperature variation with respect to the ambient temperature.

In another aspect of the present invention, a liquid crystal display includes a driving voltage generating circuit, a data driver, a gate driver and a liquid crystal display. The driving voltage generating circuit generates a driving power voltage and a gate on voltage. The driving power voltage and the gate on voltage are substantially in inverse proportion to a temperature variation of an ambient temperature. The data driver outputs a data signal in response to the driving power voltage and the gate driver to output a gate signal in response to the gate on voltage. The liquid crystal display panel displays an image in response to the data signal and the gate signal.

The driving voltage generating circuit includes a switching voltage generator circuit, a temperature-compensation feedback circuit, a driving power voltage generator circuit and a gate on voltage generator circuit. The switching voltage generator circuit is adapted to provide at an output terminal an output voltage. The switching voltage generator circuit has a control terminal for receiving a voltage control signal and generating a magnitude at the output voltage as a function of the voltage control signal. The temperature-compensation feedback circuit provides at an output terminal the control signal having a value which is a function of an ambient temperature. The output terminal of the temperature compensation feedback circuit is coupled to the control terminal of the switching voltage generator circuit. The driving power voltage generator circuit rectifies the switching driving voltage and generates a driving power voltage that is substantially inversely proportional to a temperature variation of the ambient temperature. The gate on voltage generator circuit pumps the switching driving voltage and generates a gate on voltage that is substantially inversely proportional to the temperature variation with respect to the ambient temperature.

The temperature-compensation feedback circuit includes a first resistor electrically connected between the output terminal of the switching voltage generator and a first node, a second resistor electrically connected between the first node and a ground, at least one diode having an anode coupled to the first node and a cathode coupled to the control terminal of the switching voltage generator circuit, and a third resistor electrically connected between the feedback input terminal and the ground.

The level of the switching driving voltage is lowered when the ambient temperature is increased, and the level of the switching driving voltage is highered when the ambient temperature is decreased.

In still another aspect of the present invention, a method of generating a driving power voltage for a liquid crystal display is provided as follows.

An input voltage corresponding to a feedback voltage is boosted and generated as a switching driving voltage. A level of the switching driving voltage is adjusted in consideration of a temperature variation of an ambient temperature and the adjusted switching driving voltage is outputted as the feedback voltage. The switching driving voltage is rectified and generated as the driving power voltage that is substantially in inverse proportion to the temperature variation of the ambient temperature. The switching driving voltage is pumped and generated as the gate on voltage that is substantially in inverse proportion to the temperature variation of the ambient temperature.

According to the above, the driving power voltage AVDD and the gate on voltage VON in inverse proportion to the temperature variation are applied to the liquid crystal panel, so that the liquid crystal display may uniformly maintain display quality of the image displayed thereon without relating to the temperature variation of the place where the liquid crystal display is applied.

### BRIEF DESCRIPTION OF THE DRAWINGS

The above and other advantages of the present invention will become readily apparent by reference to the following detailed description when considered in conjunction with the accompanying drawings wherein:

FIG. 1 is a block diagram showing a liquid crystal display according to an exemplary embodiment of the present invention;

FIG. 2 is a block diagram showing the driving voltage generator shown in FIG. 1;

FIG. 3 is a circuit diagram of the driving voltage generator shown in FIG. 2;

FIG. 4 is a graph illustrating operational characteristics of the diodes of the temperature-compensation feedback part 520 shown in FIG. 3;

FIG. 5 is a graph illustrating a temperature characteristic of the driving power voltage shown in FIG. 3;

FIG. 6 is a graph illustrating a temperature characteristic of the gate on voltage shown in FIG. 3;

FIG. 7A is a graph showing a gamma characteristic of a liquid crystal display operating without compensation; and

FIG. 7B is a graph showing a gamma characteristic of the liquid crystal display driven using the driving voltage generating circuit shown in FIG. 3.

### DESCRIPTION OF THE EMBODIMENTS

It will be understood that when an element or layer is referred to as being “on”, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting of the invention. As used herein, the singular forms, “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, the present invention will be explained in detail with reference to the accompanying drawings.

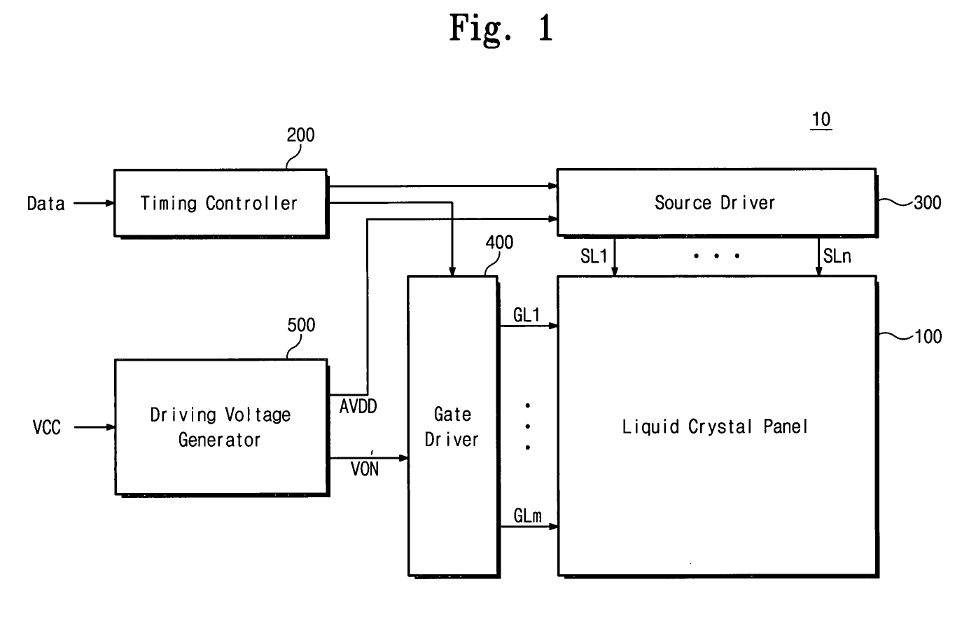

FIG. 1 is a block diagram showing a liquid crystal display according to an exemplary embodiment of the present invention.

Referring to FIG. 1, a liquid crystal display 10 includes a liquid crystal panel 100, a timing controller 200, a source driver 300, a gate driver 400 and a driving voltage generating circuit 500.

The liquid crystal panel 100 includes pixels formed in pixel regions defined by gate lines GL1, . . . , GLm and source lines SL1, . . . , SLn. Although not shown in FIG. 1, each of the pixels includes a thin film transistor that is operated as a switching device, a storage capacitor that reduces a current leakage from liquid crystal of the liquid crystal panel 100 and a liquid crystal capacitor. The thin film transistor includes a gate electrode electrically connected to a corresponding gate line of the gate lines GL1, . . . , GLm, a source electrode connected to a corresponding source lines SL1, . . . , SLn and a drain electrode connected to a pixel electrode (not shown). The thin film transistor is turned on or turned off in response to a gate driving signal inputted through the corresponding gate line of the gate lines GL1, . . . , GLm. The storage capacitor is electrically connected between the drain electrode of the thin film transistor and a ground, and the liquid crystal capacitor is electrically connected between the drain electrode of the thin film transistor and a common electrode to which a common voltage VCOM is applied.

The timing controller 200 receives image data signals from an external source. The timing controller 200 outputs the image data signals in consideration of a timing required from the source driver 300 and the gate driver 400. The timing controller 200 also outputs control signals to control the source driver 300 and the gate driver 400.

The source driver 300 includes a plurality of source driver integrated circuits (ICs). The source driver 300 outputs source driving signals to drive the source lines SL1, . . . , SLn formed on the liquid crystal panel 100 in response to the control signal from the timing controller 200 and a driving power voltage AVDD from the driving voltage generator 500. The source driving signals applied to the source lines SL1, . . . , SLn from the source driver 300 are applied to the pixel electrode as a pixel voltage when the thin film transistor is turned on in response to the gate driving signal.

The gate driver 400 includes a plurality of gate driver ICs. The gate driver 400 outputs gate driving signals to drive the gate lines GL1, . . . , GLm formed on the liquid crystal panel 100 which intersect with the source lines SL1, . . . , SLn. Although not shown in FIG. 1, the gate driver 400 includes a shift register that sequentially outputs a scan pulse in response to the control signal from the timing controller 200 and a level shifter that shifts the scan pulse to have a voltage level suitable for driving the liquid crystal. When the scan pulse is sequentially applied to the thin film transistors as a gate on voltage VON, the thin film transistors are sequentially turned on and the source driving signals are applied to a corresponding pixel electrode.

The driving voltage generating circuit 500 generates the driving power voltage AVDD and the gate on voltage VON for the liquid crystal display 10 in response to an input power voltage VCC from an exterior. The source driver 300 applies the pixel voltage to the liquid crystal panel 100 with reference to the driving power voltage AVDD generated from the driving voltage generating circuit 500 and applied to the source driver 300. In order to uniformly maintain the transmittance of the liquid crystal without regard to a temperature variation of the place where the liquid crystal display 10 is used, the magnitude of the driving power voltage AVDD is varied as a function of temperature variation, thereby varying the pixel voltage applied to the pixel electrodes.

In other words, although the voltage difference between the pixel voltage applied to the pixel electrode and the common voltage applied to the common electrode is uniformly maintained, the transmittance of the liquid crystal is highered when the liquid crystal display 10 is used at a temperature lower than the room temperature, and the transmittance of the liquid crystal is lowered when the liquid crystal display 10 is used at a temperature higher than the room temperature. Thus, when the liquid crystal display 10 is used at a temperature lower than the typical room temperature, the pixel voltage is increased such that the voltage difference between the pixel voltage and the common voltage becomes greater. In contrast, when the liquid crystal display 10 is used at a temperature higher than typical room temperature, the pixel voltage is reduced such that the voltage difference between the pixel voltage and the common voltage becomes smaller. Thus, the transmittance of the liquid crystal may be uniformly maintained without regard to the temperature variation of the place where the liquid crystal display 10 is applied.

The gate on voltage VON generated by the driving voltage generating circuit 500 is applied to the gate driver 400 to turn on or turn off the thin film transistors in the liquid crystal panel 100. In order to turn on or turn off the thin film transistors, the gate on voltage VON has a voltage level higher than about +20 volts and a gate off voltage has a voltage level lower than about −5 volts.

The thin film transistors have an operational characteristic for varying a charge rate of the liquid crystal capacitor due to the temperature variation of the place where the liquid crystal display 10 is applied. Thus, in order to uniformly maintain the operational characteristic of the thin film transistors, the gate on voltage VON applied to the thin film transistors has a voltage level which is in inverse proportion to the temperature variation. For instance, when the temperature of the place where the liquid crystal display 10 is used is lower than typical room temperature, the gate on voltage VON applied to the thin film transistor is increased since the operational characteristic of the thin film transistor is reduced, thereby preventing the charge rate of the liquid crystal capacitor from being lowered. On the contrary, when the temperature of the place where the liquid crystal display 10 is used is higher than typical room temperature, the gate on voltage VON is lowered since the operational characteristic of the thin film transistor is improved, to thereby prevent the charge rate of the liquid crystal capacitor from being overcharged.

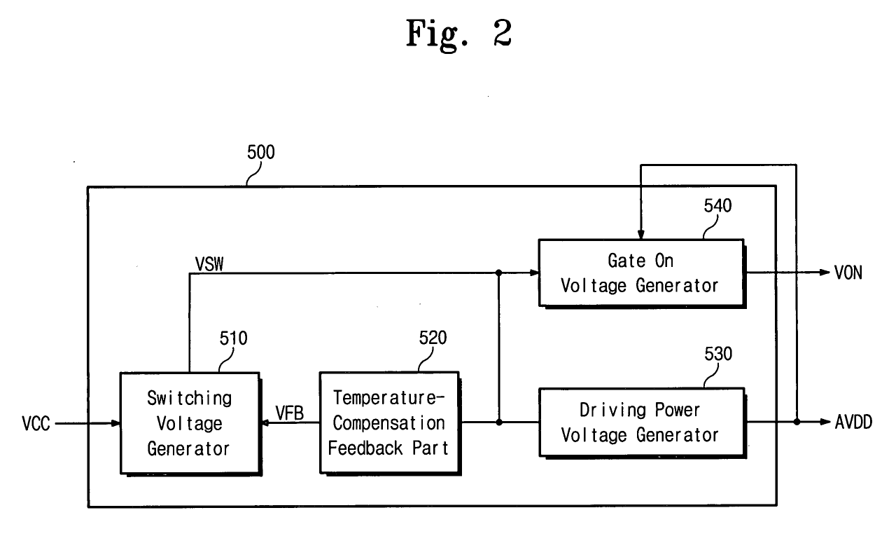

FIG. 2 is a block diagram showing the driving voltage generating circuit 500 shown in FIG. 1.

Referring to FIG. 2, the driving voltage generating circuit 500 includes a switching voltage generator circuit 510, a temperature-compensation feedback circuit 520, a driving power voltage generator circuit 530 and a gate on voltage generator circuit 540.

The switching voltage generator circuit 510 boosts the input power voltage VCC by a predetermined multiple to generate a switching pulse voltage VSW that swings between a zero voltage level and the boosted voltage level. For example, when the input power voltage VCC having a voltage level of about 3.3 volts is inputted into the switching voltage generator 510 and the switching voltage generator circuit 510 has a boosting ability of three times, the switching voltage generator circuit 510 generates the switching pulse voltage VSW that swings within a range from about zero volts and about 10 volts. The switching voltage generator circuit 510 generates the switching pulse voltage VSW having a uniform voltage level in response to a feedback voltage VFB from the temperature-compensation feedback circuit 520.

The temperature-compensation feedback circuit 520 receives the switching pulse voltage VSW from the switching voltage generator circuit 510 and performs a voltage compensation process to generate the feedback voltage VFB. The temperature-compensation feedback circuit 520 adjusts the feedback voltage VFB such that the feedback voltage VFB has a voltage level in proportion to the temperature variation. That is, when the temperature of the place where the liquid crystal display 10 is used is higher than typical room temperature, the voltage level of the feedback voltage VFB is increased, and when the temperature of the place where the liquid crystal display 10 is used is lower than typical room temperature, the voltage level of the feedback voltage VFB is reduced. Thus, the switching voltage generator circuit 510 generates the switching pulse voltage VSW having a reduced amplitude in response to the feedback voltage VFB generated when the temperature of the place is higher than typical room temperature, and the switching voltage generator circuit 510 generates the switching pulse voltage VSW having an enhanced amplitude in response to the feedback voltage generated when the temperature of the place is lower than typical room temperature.

The driving power voltage generator circuit 530 receives the switching pulse voltage VSW in inverse proportion to the temperature variation. The driving power voltage generator circuit 530 rectifies the switching pulse voltage VSW to generate the driving power voltage AVDD and stabilizes the voltage level of the driving power voltage AVDD. Thus, the driving power voltage AVDD generated by the driving power voltage generator 530 has a voltage level in inverse proportion to the temperature variation.

The gate on voltage generator circuit 540 generates the gate on voltage VON in response to the switching pulse voltage VSW from the switching voltage generator circuit 510 and the driving power voltage AVDD from the driving power voltage generator circuit 530. In the exemplary embodiment, the gate on voltage generator circuit 540 includes a charge pump circuit to generate the gate on voltage VON having a voltage level that is multiple to the voltage level of the switching pulse voltage VSW from the switching voltage generator circuit 510. Thus, the gate on voltage VON from the gate on voltage generator circuit 540 has a voltage level in inverse proportion to the temperature variation.

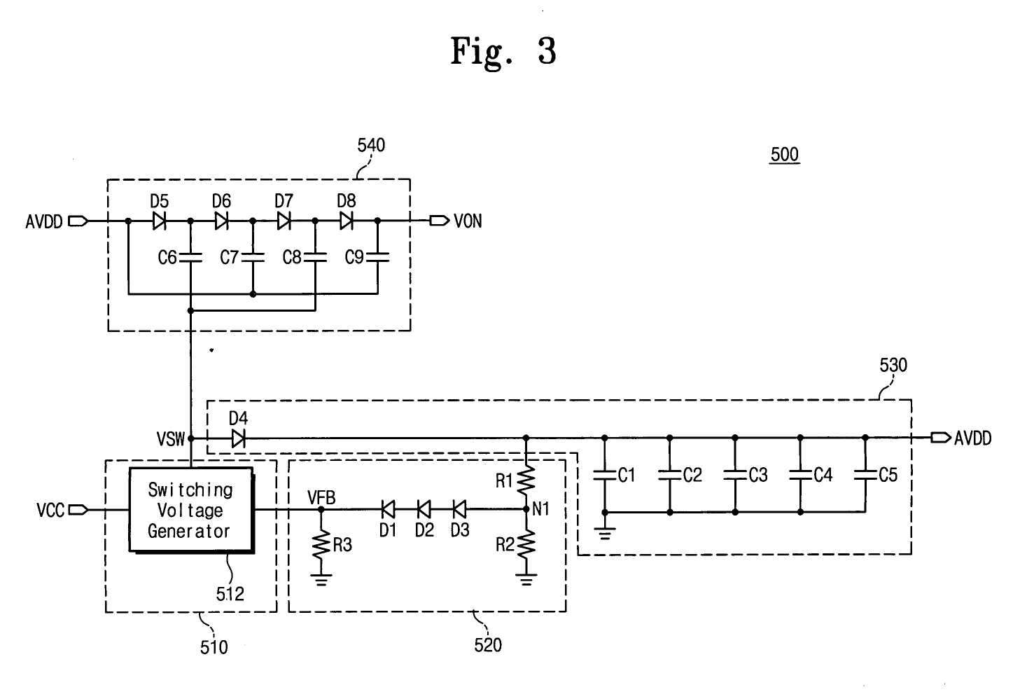

FIG. 3 is a circuit diagram of the driving voltage generator shown in FIG. 2.

Referring to FIG. 3, the switching voltage generator circuit 510 includes a direct current to direct current converter switching voltage generator 512 to boost the input power voltage VCC by the predetermined multiple and generate the switching pulse voltage VSW that swings between the zero voltage level and the boosted voltage level. The switching voltage generator 512 includes an input terminal to which the input power voltage VCC is applied, an output terminal from which the switching pulse voltage VSW is output and a feedback terminal to which the feedback voltage VFB is applied.

The voltage level of the switching pulse voltage VSW with respect to the input power voltage VCC is determined by the boosting ability of the switching voltage generator 512. Also, the switching pulse voltage VSW generated by the switching voltage generator 512 has the voltage level in an inverse proportion to the temperature variation.

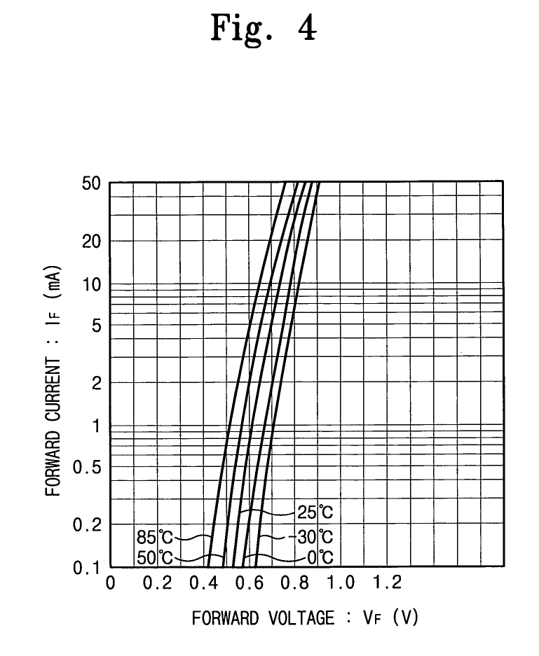

The temperature-compensation feedback circuit 520 includes a first resistor R1, a second resistor R2, a third resistor R3, a first diode D1, a second diode D2 and a third diode D3. The first and second resistors R1 and R2 are electrically connected in series between the output terminal of the switching voltage generator circuit 510 and a ground. The third resistor R3 is electrically connected between the feedback terminal of the switching voltage generator 512 and the ground. The first, second and third diodes D1, D2 and D3 are reversely connected between the feedback terminal of the switching voltage generator 512 and a first node N1 between the first and second resistors R1 and R2. Thus, the feedback voltage VFB has a voltage value obtained by subtracting a forward voltage VF (refer to FIG. 4) of the first, second and third diodes D1, D2 and D3 from a voltage at the first node N1. In the exemplary embodiment, the forward voltage VF of the first, second and third diodes D1, D2 and D3 is in inverse proportion to the temperature variation. For example, since the forward voltage VF is lower when the temperature of the place is higher, the voltage level of the feedback voltage VFB is increased. However, when the temperature of the place is lower, the voltage level of the feedback voltage VFB is reduced since the forward voltage VF of the first, second and third diodes D1, D2 and D3 is reduced. The voltage level of the switching pulse voltage VSW is represented by a following equation in consideration of the feedback voltage VFB from the temperature-compensation feedback circuit 520.

$$VSW = VFB + 3 VF + R 1 ( \frac{VFB}{R 3} + \frac{VFB + 3 VF}{R3} )$$

In FIG. 3, the temperature-compensation feedback circuit 520 having three diodes D1, D2 and D3 has been described, however the number of diodes may be greater or less. When the numbers of the diodes is increased, the temperature-compensation feedback circuit 520 generates the feedback voltage VFB which is more sensitive to the temperature variation, thereby generating the switching pulse voltage VSW that is more sensitive to the temperature variation.

The driving power voltage generator circuit 530 includes a fourth diode D4, a first capacitor C1, a second capacitor C2, a third capacitor C3, a fourth capacitor C4 and a fifth capacitor C5.

The fourth diode D4 is connected between the output terminal of the switching voltage generator circuit 510, from which the switching pulse voltage VSW is outputted, and the temperature-compensation feedback circuit 520. The fourth diode D4 rectifies the switching pulse voltage VSW to generate the driving power voltage AVDD and blocks a reverse current flowing from the temperature-compensation feedback circuit 520 to the switching voltage generator 510. The first, second, third, fourth and fifth capacitors C1, C2, C3, C4, C5 stabilize the voltage level of the driving power voltage AVDD.

Since the magnitude of switching pulse voltage VSW applied to the driving power voltage generator circuit 530 is in inverse proportion to the temperature variation, the driving power voltage AVDD generated from the driving power voltage generator circuit 530 is in inverse proportion to the temperature variation.

The gate on voltage generator circuit 540 includes the charge pump circuit. The charge pump circuit includes a fifth diode D5, a sixth diode D6, a seventh diode D7, an eighth diode D8, a sixth capacitor C6, a seventh capacitor C7, an eighth capacitor C8 and a ninth capacitor C9. The gate on voltage generator circuit 540 pumps the magnitude of the switching pulse voltage VSW with reference to the driving power voltage AVDD to generate the gate on voltage VON. The gate on voltage VON output from the gate on voltage generator circuit 540 is inversely proportional to the temperature variation since the driving power voltage AVDD and the switching pulse voltage VSW applied to the gate on voltage generator circuit 540 are inversely proportional to the temperature variation.

FIG. 4 is a graph illustrating operation characteristics of the diodes of the temperature-compensation feedback circuit 520 shown in FIG. 3.

Referring to FIG. 4, the forward voltage VF of the first, second and third diodes D1, D2 and D3 is highered according as the temperature of the place where the liquid crystal display 10 is applied is lowered. The forward voltage VF is inversely proportional to the temperature variation affects the feedback voltage VFB and the feedback voltage VFB affects the switching pulse voltage VSW. Thus, the switching pulse voltage VSW is inversely proportional to the temperature variation.

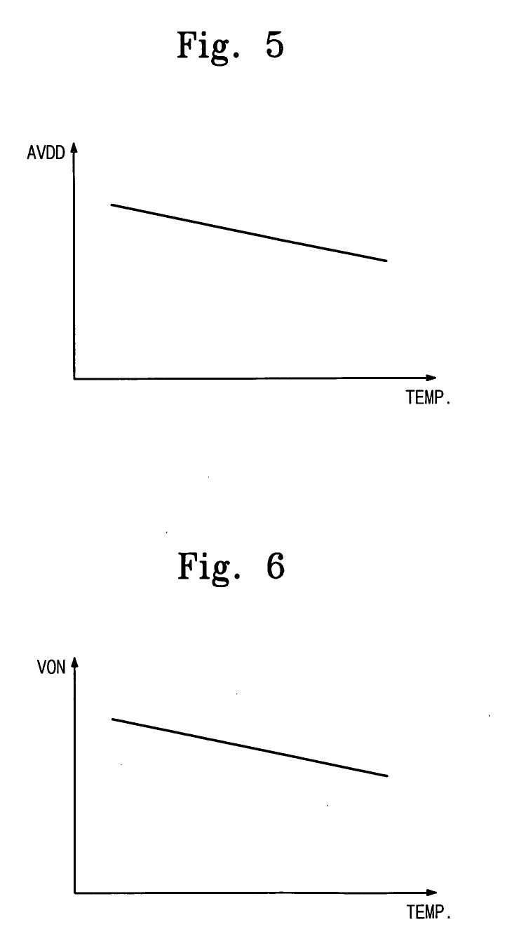

FIG. 5 is a graph illustrating a temperature characteristic of the driving power voltage shown in FIG. 3.

Referring to FIG. 5, the driving power voltage AVDD generated by rectifying the switching pulse voltage VSW is in inverse proportion to the temperature variation since the switching pulse voltage VSW from the switching voltage generator circuit 510 is in inverse proportion to the temperature variation due to the temperature-compensation feedback circuit 520.

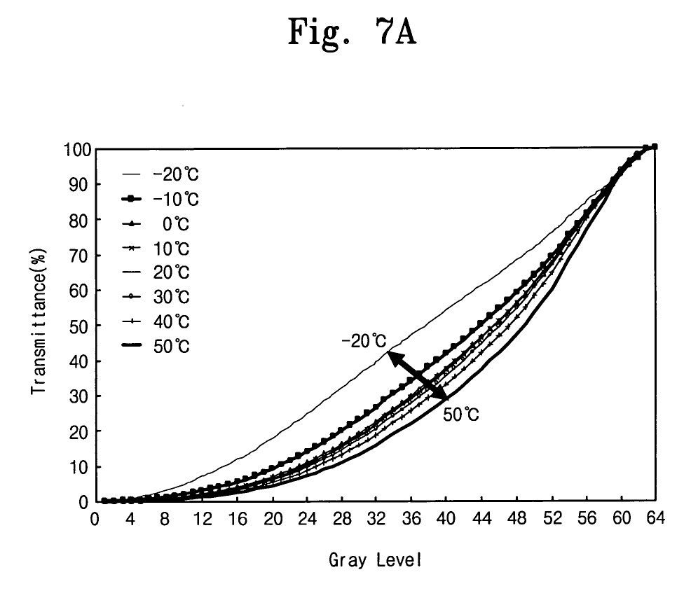

FIG. 6 is a graph illustrating a temperature characteristic of the gate on voltage shown in FIG. 3.

As shown in FIG. 6, when the temperature of the place where the liquid crystal display 10 is used is increased, the voltage level of the gate on voltage VON is reduced. That is, since the gate on voltage VON is generated by pumping the switching pulse voltage VSW, the voltage level of the gate on voltage VON is in inverse proportion to the temperature variation.

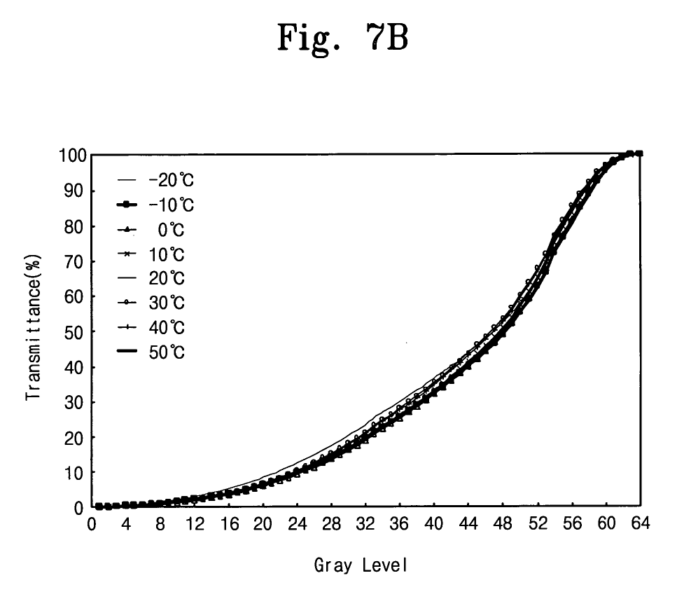

FIG. 7A is a graph showing a gamma characteristic of a liquid crystal display which does not employ the driving voltage generating circuit such as that shown in FIG. 3, and FIG. 7B is a graph showing a gamma characteristic of the liquid crystal display to which the driving voltage generating circuit shown in FIG. 3 is applied.

As shown in FIG. 7A, in a conventional system in which a uniform voltage level is applied without regard to the temperature variation of the place where the liquid crystal display 10 is used, the image displayed on the liquid crystal display varies as a function of the temperature variation of the place where the liquid crystal display is used.

However, when the driving voltage generating circuit 500 compensates the driving power voltage AVDD and the gate on voltage VON in view of the temperature variation, the driving power voltage AVDD and the gate on voltage VON in inverse proportion to the temperature variation may be generated from the driving voltage generating circuit 500, thereby displaying the uniform image on the liquid crystal display 10 without relating to the temperature variation.

As described above, the driving voltage generating circuit 500 generates the driving power voltage AVDD and the gate on voltage VON in inverse proportion to temperature variation. Then, the driving power voltage AVDD and the gate on voltage VON in inverse proportion to the temperature variation are applied to the liquid crystal panel 100, so that the liquid crystal display 10 may uniformly maintain display quality of the image displayed thereon without regard to the temperature of the place where the liquid crystal display 10 is used.

The driving voltage generating circuit according to the exemplary embodiment may be applied to various display apparatii, such as an electrochromic display device, a digital mirror device, an actuated mirror device, a grating light value device, a plasma display panel, an electroluminescent display device, a light emitting diode display device, and a vacuum fluorescent display device.

Further, the liquid crystal display employing the driving voltage generating circuit may be applied to various electronics, such as a large-sized television set, a high definition television set, a mobile computer, a camcorder, a display device for vehicles, a telecommunication multimedia or the like.

According to the above, since the magnitude of driving power voltage AVDD and the gate on voltage VON are provided in inverse proportion to the temperature variation are applied to the liquid crystal panel 100, the liquid crystal display 10 may uniformly maintain display quality of the image displayed thereon without relating to the temperature variation of the place where the liquid crystal display 10 is applied.

Although exemplary embodiments of the present invention have been described, it is understood that the present invention is not limited to these exemplary embodiments, but various changes and modifications can be made within the spirit and scope of the present invention as hereinafter claimed.

What is claimed is:

1. A driving voltage generating circuit, comprising:
a switching voltage generator circuit adapted to provide at an output terminal an output voltage, the switching voltage generator circuit having a control terminal for receiving a voltage control signal and generating a magnitude at the output voltage as a function of the voltage control signal;
a temperature-compensation feedback circuit providing at an output terminal the control signal having a value which is a function of an ambient temperature, wherein the output terminal of the temperature compensation feedback circuit is coupled to the control terminal of the switching voltage generator circuit;
a driving power voltage generator circuit to rectify the switching driving voltage and generate a driving power voltage that is substantially inversely proportional to a temperature variation of the ambient temperature; and
a gate on voltage generator circuit to pump the switching driving voltage and generate a gate on voltage that is substantially inversely proportional to a temperature variation with respect to an ambient temperature.

2. The driving voltage generating circuit of claim 1, wherein the temperature-compensation feedback circuit comprises:
a first resistor electrically coupled between the output terminal of the switching voltage generator and a first node;
a second resistor electrically connected between the first node and ground;
at least one diode having an anode coupled to the first node and a cathode coupled to the control terminal of the switching voltage generator; and
a third resistor electrically connected between the control terminal and the ground.

3. The driving voltage generating circuit of claim 2, wherein the temperature-compensation feedback circuit adjusts the level of the switching driving voltage using an operational characteristic of the diode with respect to the temperature variation of the ambient temperature.

4. The driving voltage generating circuit of claim 2, wherein the level of the switching driving voltage is lowered when the ambient temperature is increased, and the level of the switching driving voltage is increased when the ambient temperature is decreased.

5. A liquid crystal display comprising:
a driving voltage generating circuit for generating a driving power voltage and a gate on voltage, the driving voltage generating circuit being adapted to provide the driving power voltage and the gate on voltage substantially in inverse proportion to a temperature variation from an ambient temperature;
a data driver to output a data signal in response to the driving power voltage;
a gate driver to output a gate signal in response to the gate on voltage; and
a liquid crystal display panel to display an image thereon in response to the data signal and the gate signal.

6. The liquid crystal display of claim 5, wherein the driving voltage generating circuit comprises:
a switching voltage generator circuit adapted to provide at an output terminal an output voltage, the switching voltage generator circuit having a control terminal for receiving a voltage control signal and generating a magnitude at the output voltage as a function of the voltage control signal;
a temperature-compensation feedback circuit providing at an output terminal the control signal having a value which is a function of an ambient temperature, wherein the output terminal of the temperature compensation feedback circuit is coupled to the control terminal of the switching voltage generator circuit;
a driving power voltage generator circuit to rectify the switching driving voltage and generate a driving power voltage that is substantially inversely proportional to a temperature variation of the ambient temperature; and
a gate on voltage generator circuit to pump the switching driving voltage and generate a gate on voltage that is substantially inversely proportional to a temperature variation with respect to an ambient temperature.

7. The liquid crystal display of claim 6, wherein the temperature-compensation feedback circuit comprises:
a first resistor electrically coupled between the output terminal of the switching voltage generator and a first node;
a second resistor electrically connected between the first node and ground;
at least one diode having an anode coupled to the first node and a cathode coupled to the control terminal of the switching voltage generator; and
a third resistor electrically connected between the control terminal and the ground.

8. The liquid crystal display of claim 6, wherein the temperature-compensation feedback circuit adjusts the level of the switching driving voltage using an operational characteristic of the diode with respect to the temperature variation of the ambient temperature.

9. The liquid crystal display of claim 8, wherein the level of the switching driving voltage is lowered when the ambient temperature is increased, and the level of the switching driving voltage is increased when the ambient temperature is decreased.

10. A method of generating a driving voltage for a liquid crystal display, comprising:
boosting an input voltage to generate a switching driving voltage in response to a feedback voltage;
adjusting a level of the switching driving voltage corresponding to a temperature variation of an ambient temperature to output the adjusted switching driving voltage as the feedback voltage;
rectifying the switching driving voltage to generate the driving power voltage that is substantially in inverse proportion to the temperature variation of the ambient temperature; and
pumping the switching driving voltage and generate the gate on voltage that is substantially in inverse proportion to the temperature variation of the ambient temperature.

11. The method of claim 10, wherein the level of the switching driving voltage is lowered when the ambient temperature is highered, and the level of the switching driving voltage is highered when the ambient temperature is lowered.
